(19) United States
(12) Patent Application Publication
(10) Pub. No.: US 2023/0069757 A1
(43) Pub. Date: Mar. 2, 2023

(54) STREET SWEEPER WITH AN AUTOMATIC CLEANING SYSTEM FOR CLEANING A RECYCLING SYSTEM

(71) Applicant: Marcel Boschung AG, Payerne (CH)

(72) Inventors: Benedikt STURNY, Dudingen (CH); Didier NEUHAUS, Bulle (CH)

(21) Appl. No.: 17/900,246

(22) Filed: Aug. 31, 2022

(30) Foreign Application Priority Data
Sep. 1, 2021 (EP) 21194243.8

(51) Int. Cl. E01H 1/08; A47L 5/22; A47L 9/14; A47L 7/00; B08B 9/032; A47L 9/28

(52) U.S. Cl. CPC E01H 1/0845; A47L 5/22; A47L 9/1409; A47L 7/0033; B08B 9/0326; B08B 9/0325; A47L 9/2836

(57) ABSTRACT

A street sweeper comprises a dirt container and a suction device. The suction device comprises a suction mouth, a suction channel and a suction fan. The suction fan generates a suction flow which leads into the dirt container. Furthermore, the street sweeper comprises a recycling system with a separating device. The separating device separates sucked-in dirty water from the dirt container into the recycling system. Furthermore, the street sweeper comprises a fresh-water tank in which fresh-water is stored. Furthermore, a cleaning device is provided by means of which at least a part of the recycling system can be cleaned. The fresh-water from the fresh-water tank is used for cleaning the recycling system.

### FIELD OF THE INVENTION

The invention relates to a street sweeper with a dirt container and a suction device. The suction device comprises a suction mouth, a suction channel and a suction fan. The suction device guides a suction flow to the dirt container. Furthermore, the street sweeper comprises a recycling system with a separating device. The separating device separates dirty water from the dirt tank into the recycling system so that recycled water can be reused. Furthermore, the street sweeper comprises a fresh-water tank in which fresh-water is stored.

### BACKGROUND

Street sweepers are used to clean roads. They usually have disc brushes with which dirt is sucked through a suction mouth and a suction channel into a dirt tank. Nozzles spray fresh-water onto the road in front of the disc brushes. This reduces the whirling up of dust. The sprayed water is sucked up together with the dirt and transported into the dirt container.

Additional nozzles spray water into the suction mouth and into the suction channel. The sprayed water binds the dust at a high flow rate inside the suction channel. The dust remains in the dirt container and does not escape from the street sweeper via the exhaust air opening of the dirt container.

A street sweeper can only carry a limited amount of fresh-water and fresh-water consumption should always be reduced for ecological reasons. The street sweeper therefore has a recycling system. The dirty water that is sucked is recycled and can be reused within the street sweeper.

Drivers of a street sweeper are trained to clean the recycling system when emptying the dirt container and/or daily, so that the functionality of the recycling system is not impaired.

### DISCLOSURE OF THE INVENTION

The problem is to provide a street sweeper with a user-friendly recycling system.

This problem is solved by the subject of independent claim 1. Accordingly, a street sweeper comprises a dirt container and a suction device. The suction device comprises a suction mouth, a suction channel and a suction fan. The suction fan generates a suction flow which leads into the dirt container. Furthermore, the street sweeper comprises a recycling system with a separation device. The separating device separates sucked-in dirty water from the dirt container into the recycling system.

A recycling system is a system that allows reusing dirty water within the street sweeper. The recycling system can treat and clean the dirty water. However, this is not mandatory. The only relevant factor for the definition of the recycling system is the reuse of the dirty water within the street sweeper.

Reuse means that the dirty water does not remain in the dirt tank until the dirt tank is emptied, but is used in another form within the street sweeper.

Furthermore, the street sweeper comprises a fresh-water tank in which fresh-water is stored. Furthermore, a cleaning device is provided by means of which at least a part of the recycling system can be cleaned. The fresh-water from the fresh-water tank is used for cleaning the recycling system.

The presence of a cleaning device has the advantage that the recycling system can be cleaned in a simple way. For example, it is not necessary for the driver of the street sweeper to clean the recycling system with an external cleaning device, such as an external high-pressure cleaning system. This task is performed by the cleaning device built into the street sweeper, which is specifically designed to clean the recycling system. The recycling system can therefore be cleaned effectively and also efficiently. The recycling system functions permanently and no time-consuming maintenance work is required. The street sweeper is extremely user-friendly in its operation.

Advantageously, the street sweeper is configured such that the recycled water is not fed to the fresh-water tank and/or is not fed to existing cleaning brushes, in particular disc brushes. In particular, the recycled water is fed, in particular sprayed, into the suction mouth and/or into the suction channel. The recycled water is not used where absolutely clean water is required. The recycled water does not have to be elaborately treated and cleaned, but it may also contain a certain amount of dirt. The dirt content in the recycled water leads to the problem that certain sections of the recycling system become dirty or clogged. The cleaning device solves this problem by cleaning the recycling system regularly.

Advantageously, the recycling system has a recycling conduit. The recycled water flows in a first flow direction from the dirt tank through the recycling conduit. In particular, the recycling conduit leads the recycled water from the dirt container to the suction mouth and/or to the suction channel.

“From the dirt tank” does not mean that the recycling conduit must be directly connected to the dirt tank. It only means that the recycling conduit carries recycled water that has been taken from the dirt tank.

By means of the cleaning device, at least a section of the recycling conduit, in particular the complete recycling conduit, is cleaned. For example, the cleaning device sprays a high-pressure water jet into the recycling conduit. This water jet can be continuous or pulsating. With such a system, the recycling conduit can be cleaned effectively and also efficiently.

The term high pressure water jet is known to the skilled person. In particular, a high-pressure water jet is associated with a pressure build-up of at least 15 bar.

Advantageously, the cleaning device receives fresh-water from the fresh-water tank and guides or sprays the fresh-water in a second flow direction through a section of the recycling conduit, in particular through the complete recycling conduit. The first and second flow directions can be in the same direction or opposite. In the same direction, the dirt is conveyed in particular to the suction device and in the opposite direction, the dirt is conveyed in particular to the dirt container.

It is also possible that in a first section of the recycling conduit the first and second flow directions are opposite and in a second section they are in the same direction. For example, in a section of the recycling conduit close to the dirt container, the cleaning device sprays the fresh-water in the opposite direction so that the dirt is transported towards the dirt container.

In a second section of the recycling conduit, the first and second flow directions can then be in the same direction, so that the cleaning device sprays the dirt towards the suction device by means of the fresh-water.

The described cleaning device integrated in the street sweeper has the advantage that fresh-water can be sprayed into the recycling conduit at an optimal position and in an optimal direction. An optimal cleaning result is possible, and the recycling conduit can be cleaned effectively and efficiently. In other words, the cleaning is done in a very short time, the fresh-water consumption is minimised, and the cleaning result is good, so that a permanent operation of the recycling system is ensured.

Advantageously, the recycling system includes a recycling water tank. Recycled water is collected in this tank. This recycling water tank can be part of the dirt tank, i.e., it can be arranged inside the dirt tank. However, the recycling water tank can also be arranged outside the dirt tank.

An arrangement inside the dirt container has the advantage that the recycling system can be designed as compactly as possible.

Advantageously, the street sweeper comprises a control. The control can automatically control the cleaning device. For example, the control activates the cleaning device automatically after a certain operating or driving time. In addition to the driving time, the operating time also includes idle time during which the street sweeper is in operation.

In particular, the cleaning device is activated in each case after a time interval of no more than five minutes, in particular no more than two minutes, in particular no more than one minute, in particular no more than 30 seconds. The automatic activation has the advantage that the cleaning is not forgotten, and the proper functioning of the recycling system is permanently guaranteed.

The control can also automatically activate the street sweeper after a certain driving distance has been travelled, i.e., it is not the time but the distance driven that is measured. Additionally, or alternatively, the driver of the vehicle can give a signal to the control, for example by pressing a button, and the control can activate the cleaning device.

In particular, the control activates the cleaning device periodically and for a maximum of 30 seconds at a time, in particular a maximum of ten seconds, in particular a maximum of five seconds, in particular a maximum of two seconds. In contrast to manual cleaning by the vehicle driver, the automatic cleaning device has the advantage that the recycling system can be cleaned in very short cycles. The operation of the street cleaning does not have to be interrupted.

In particular, the recycling system includes a recycling device for treating the dirty water. The recycling device provides recycled water. The recycling device can, for example, be designed as a filter, in particular as a filter plate.

Advantageously, a spraying device is provided with which fresh-water is sprayed in front of the cleaning brushes of the street sweeper.

### BRIEF DESCRIPTION OF THE DRAWINGS

Further embodiments, advantages and applications of the invention are described by the dependent claims and by the following description based on FIG. 1.

FIG. 1 schematically shows the construction of a street sweeper with an integrated recycling system and a cleaning device.

### DETAILED DESCRIPTION OF THE INVENTION

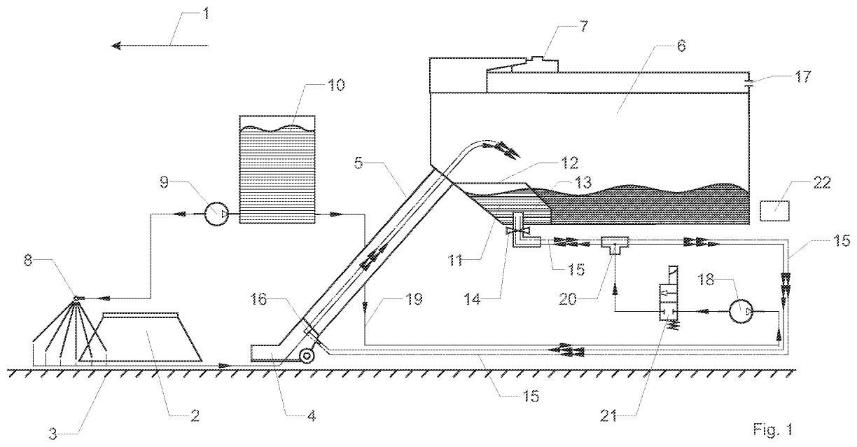

FIG. 1 shows the schematic structure of a street sweeper according to the invention. The street sweeper is a vehicle with wheels, an engine room and a driver's cab. The driver's cab and wheels are not shown in FIG. 1. FIG. 1 shows the view of the vehicle from the left. I.e., the front of the vehicle is on the left. The rear of the vehicle is on the right. The direction of travel of the street sweeper is in the direction of arrow 1.

Disc brushes 2 are arranged at the front of the street sweeper. These disc brushes 2 wipe the dirt present on the street 3 into a suction mouth 4. The suction mouth 4 is arranged below the driver's cab, which is not shown.

A suction channel 5 connects the suction mouth 4 with a dirt container 6. A suction fan 7 arranged at the dirt container 6 sucks the wiped dirt through the suction mouth 4 and through the suction channel 5 into the dirt container 6. The dirt container 6 collects the sucked-in dirt. The driver must empty the dirt container 6 regularly.

Nozzles 8 are arranged at the front of the disc brush 2 and, in the present exemplary embodiment, at the front of the street sweeper. These nozzles 8 spray fresh-water onto the street 3. A pump 9 pumps the fresh-water from a fresh-water tank 10 to the nozzles 8. The fresh-water tank 10 is arranged in the engine room and may have a volume of 200 litres, for example. The direction of flow from the fresh-water tank 10 to the nozzles 8 is shown in FIG. 1 by 1-fold arrows. Spraying the streets 3 with water prevents dust and fine dust particles from being stirred up.

The suction stream flowing through the suction mouth 4 and the suction channel 5 into the dirt tank 6 thus carries not only dirt but also the fresh-water sprayed by means of the nozzles 8. If it rains during operation of the street sweeper, rainwater also enters the dirt tank 6 through the suction mouth 4. This mixture of dirt and freshwater, and possibly also rainwater, is referred to below as dirty water.

The street sweeper has a recycling system in the machine room. The purpose of the recycling system is to reuse the dirty water sucked into the dirt tank 6. The recycling system comprises a recycling water tank 11 in which recycled water is stored. In the present case, the recycled water tank 11 is arranged inside the dirt tank 6.

The recycling system comprises a separating device 12, in this case in the form of a filter plate, which filters the dirty water and thus removes a large part of the dirt from the dirty water. However, the filter plate allows fine dust and fine sand to pass through. The dirty water that flows through the separating device 12 is called recycled water after it has been filtered. The recycled water is stored in the recycling water tank 11.

An outlet 13 with a valve 14 is arranged on the underside of the recycling water tank 11. When the valve 14 is open, recycled water flows out of the recycling water tank 11 into a recycling conduit 15. The direction of flow of the recycled water is indicated by double arrows throughout FIG. 1.

The recycling conduit 15 leads the recycled water to nozzles 16, which spray the recycled water into the suction mouth 4 and into the suction channel 5. By spraying water into the suction mouth 4 and into the suction channel 5, dust is bound at a high flow rate in the suction channel 5, so that the dust does not escape again from the street sweeper into the environment via the exhaust air of the outlet opening 17 of the dirt container 6.

As mentioned, the filter plate 12 does not filter all dirt from the dirty water. The recycled water is therefore contaminated with fine sand and fine dust within the recycling system. This residual dirt is deposited in the outlet 13, in the recycling conduit 15 and in the nozzles 16. The recycling system can therefore become clogged, or its functionality can at least be impaired.

For this reason, a cleaning device is provided in the street sweeper with which the recycling system can be cleaned. In particular, the outlet 13, the recycling conduit 15 and the nozzles 16 can be cleaned. The cleaning device comprises a pump 18 and a supply line 19. The pump 18 pumps fresh-water from the fresh-water tank 10 through the supply line 19 into the recycling conduit 15. Entry into the recycling conduit 15 is via an access 20. Also present in this exemplary embodiment is a valve 21 with which the supply of fresh-water can be additionally controlled. However, it is also possible to control the supply of fresh-water only by switching the pump 18 on and off. The direction of flow of the fresh-water from the fresh-water tank 10 to the inlet 20 is marked with 1-fold arrows in FIG. 1.

The fresh-water is sprayed into the recycling conduit 15 by means of high pressure. The fresh-water sprayed into the recycling conduit 15 under high pressure flows through the recycling conduit 15. The direction of flow is indicated by triple arrows in FIG. 1. Between the access 20 and the recycling tank 11, the injected fresh-water flows in the opposite direction to the flow direction of the recycled water. The dirt deposited in the recycling conduit 15 and in the drain 13 is conveyed back into the recycling tank 11. In the other direction, namely from the access 20 to the suction mouth 16, the fresh-water is sprayed in the same direction as the recycled water flows. The dirt deposited in the recycling conduit is conveyed into the suction mouth 16 and from there enters the dirt tank 6. The dirt enters the dirt tank 6 due to the suction effect of the suction fan 7.

Furthermore, the street sweeper has a control 22 which, among other things, controls the cleaning device. The cleaning process, i.e., the spraying of high-pressure fresh-water into the recycling conduit 15, is activated periodically during the operation of the street sweeper, for example after a time interval of 30 seconds. The duration of the cleaning is limited to a few seconds. However, the time interval and the cleaning duration are only exemplary specifications. The control of the cleaning process can also be activated depending on the distance travelled, for example.

The driver of the street sweeper can also activate the cleaning device manually and for any length of time. For example, the driver activates the cleaning device when he reaches a hydrant. In this way, he can clean the recycling system, but then completely refill the fresh-water tank.

In addition, the high-pressure jet may, for example, have a constant water pressure or be pulsating.

While preferred embodiments of the invention are described in the present application, it should be clearly noted that the invention is not limited to these and may also be carried out in other ways within the scope of the following claims.

1. A street sweeper comprising:
a dirt container,
a suction device comprising a suction mouth, a suction channel and a suction fan for guiding a suction flow into the dirt container,
a recycling system comprising a separating device, configured to separate and reuse sucked-in dirty water from the dirty water tank as recycled water,
a fresh-water tank containing fresh-water,
wherein the street sweeper comprises a cleaning device configured to clean at least part of the recycling system by means of the fresh-water from the fresh-water tank.

2. The street sweeper according to claim 1, wherein the street sweeper is configured such that the recycled water
is not fed to the fresh-water tank, and/or
is not fed to cleaning brushes.

3. The street sweeper according to claim 1, wherein the recycled water is fed, in particular sprayed, into the suction mouth and/or into the suction channel.

4. The street sweeper according to claim 1, wherein the recycling system comprises a recycling conduit, wherein the recycled water flows in a first flow direction from the dirt container through the recycling conduit.

5. The street sweeper according to claim 4, wherein the recycled water flows through the recycling conduit to the suction mouth and/or to the suction channel.

6. The street sweeper according to claim 4, wherein at least a section of the recycling conduit, in particular the complete recycling conduit, can be cleaned by means of the cleaning device, in particular
by means of a high-pressure water jet, or
by means of a pulsating water jet.

7. The street sweeper according to claim 4, wherein the cleaning device is configured to guide, in particular to spray, fresh-water in a second flow direction through a section of the recycling conduit, in particular through the complete recycling conduit.

8. The street sweeper according to claim 7, wherein the first flow direction and the second flow direction are opposite within the recycling conduit,
in particular wherein the second flow direction is towards the dirt container.

9. The street sweeper according to claim 7, wherein the first flow direction and the second flow direction are in the same direction within the recycling conduit,
in particular wherein the second flow direction is towards the suction mouth and/or suction channel.

10. The street sweeper according to claim 7, wherein in a first section of the recycling conduit the first flow direction and the second flow direction are opposite and in a second section of the recycling conduit the first flow direction and the second flow direction are in the same direction.

11. The street sweeper according to claim 1, wherein the recycling system comprises a recycling water tank for collecting recycled recycling water,
in particular wherein the recycling water tank is arranged inside the dirt tank or outside the dirt tank.

12. The street sweeper according to claim 1, comprising a control, configured such that the control activates the cleaning device, in particular
automatically after a certain driving or operating period, or
automatically after a certain driving distance has been travelled, or
after the control has received an activation signal from the user.

13. The street sweeper according to claim 12, wherein the control is configured to activate the cleaning device at time intervals of at most five minutes, in particular at most two minutes, in particular at most one minute, in particular at most 30 seconds.

14. The street sweeper according to claim 12, wherein the control periodically activates the cleaning device for a maximum of 30 seconds at a time, in particular a maximum of ten seconds, in particular a maximum of five seconds, in particular a maximum of two seconds.

15. The street sweeper according to claim 1, wherein the recycling system comprises a recycling device for treating the dirty water and providing recycled water,
in particular wherein the recycling device is a filter, in particular a filter plate.
